(19) United States
(12) Patent Application Publication
(10) Pub. No.: US 2012/0259581 A1
(43) Pub. Date: Oct. 11, 2012

(54) APPARATUS, SYSTEM AND METHOD FOR PROVIDING GARMENT FITTING IDENTIFICATION

(76) Inventor: David Gwaltney, Mechanicsville, VA (US)

(21) Appl. No.: 13/084,351

(22) Filed: Apr. 11, 2011

(51) Int. Cl. G06F 15/00; G06K 19/07; G06K 19/06

(52) U.S. Cl. 702/155; 235/493; 235/492

(57) ABSTRACT

A system, apparatus and method for providing garment fitting identification are provided. Data indicative of a consumer's body measurements is analyzed and a composite reference number that represents measurements and indicia of the consumer's garment size is generated based on a standard measurement system.

### BACKGROUND

1. Field

The present invention generally relates to a garment fitting identification system. More specifically, the present invention relates to a garment fitting identification system that provides a numerical representation of measurements and indicia for a user.

2. Description of the Related Art

For most of human history, clothing was traditionally made by seamstresses, who took custom body measurements prior to construction. However, due to mass production of uniforms in the American Civil War, the development of standard sizes was necessitated. Standard measurements for clothing were recorded and published by the U.S. Department of Agriculture in several iterations from the 1930's until 1971, the most widely accepted of these being the Voluntary Commercial Standard (CS) 215-58, which was superceded by the Voluntary Product Standard PS 42-70.

However, commercial standard sizing lost popularity among manufacturers during the 1970's. As women began to wear clothing that had traditionally been worn by men, such as jeans, chinos, button-down dress shirts and polo shirts, unisex sizing was used to describe garments. For instance, clothes were marked as small (S), medium (M) and large (L). Soon, manufacturers introduced extra small (XS) and extra large (XL). Accordingly, the Voluntary Product Standard was officially withdrawn on Jan. 20, 1983. Today, garments in sizes up to 5XL may be found as the size of the American population increases. In return for simple labeling the need to produce fewer sizes of clothing, manufacturers sacrificed a more optimal fit for many customers.

### SUMMARY

Certain embodiments of the present invention may provide solutions to the problems and needs in the art that have not yet been fully solved by conventional sizing systems for garments. For example, certain embodiments of the present invention represent sizing information in the form of a concise reference number by which a consumer can maintain a record of body measurements in the form of a single string of digits.

In one embodiment of the present invention, a computer program is embodied on a non-transitory computer-readable medium. The computer program is configured to cause a processor to analyze data indicative of a consumer's body measurements. The computer program is also configured to cause the processor to generate a composite reference number that represents measurements and indicia of the consumer's garment size based on a standard measurement system.

In another embodiment of the present invention, an apparatus includes physical memory and a processor configured to read information from, and write information to, the physical memory. The processor is configured to analyze data retrieved from the memory that is indicative of a consumer's body measurements. The processor is also configured to generate a composite reference number that represents measurements and indicia of the consumer's garment size based on a standard measurement system. The processor is further configured to output the composite reference number to a visual display device, a printer, or a card reader/writer.

In yet another embodiment of the present invention, a method includes analyzing, via a processor, data that is indicative of a consumer's body measurements. The method also includes generating, via the processor, a composite reference number that represents measurements and indicia of the consumer's garment size based on a standard measurement system. The method further includes transmitting the composite reference number to a computer system or network of a retailer or manufacturer and identifying a pre-made article, or manufacturing a new article, that fits the consumer based on the composite reference number.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a system for providing a garment identification code, according to an embodiment of the present invention.

FIG. 2 illustrates a composite reference number for representing garment sizes, according to an embodiment of the present invention.

FIG. 3 illustrates a flowchart for a garment fitting identification system, according to an embodiment of the present invention.

FIG. 4 illustrates a flowchart for a garment fitting identification system, according to an embodiment of the present invention.

FIG. 5A illustrates a smart card storing a composite reference number, according to an embodiment of the present invention.

FIG. 5B illustrates a card with a magnetic strip storing a composite reference number, according to an embodiment of the present invention.

FIG. 5C illustrates a card on which a composite reference number is printed, according to an embodiment of the present invention.

FIG. 6 illustrates the Women's Misses table of the Voluntary Product Standard, according to an embodiment of the present invention.

### DETAILED DESCRIPTION

It will be readily understood that the components of various embodiments of the present invention, as generally described and illustrated in the figures herein, may be arranged and designed in a wide variety of different configurations. Thus, the following more detailed description of the embodiments of the systems, apparatuses and methods of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

The numerous non-standard unisex sizing labels, such as XS, S, M, L, XL, XXL, 3XL, etc., have left consumers confused when shopping for clothing according to garment fit, particularly as Internet shopping has become pervasive. It is generally not possible to try clothing on prior to purchase, so consumers can generally not be sure that clothing they order will fit well. Further, an “S” from one manufacturer is not the same as an “S” from another, and some manufacturers intentionally create garments that are atypically large to make potential customers feel better about their size and thus increase the likelihood of making a sale. These practices render unisex sizing labels unreliable.

Certain embodiments of the present invention remedy the problem of unreliable unisex sizing by representing sizing information in the form of a concise reference number by which a consumer can maintain a record of body measurements in the form of a single string of digits, or code, which may subsequently be imprinted on a card for convenient access. Such a code may be represented in any numerical form, such as base-10, hexadecimal or binary. The code may also be represented as a one-dimensional or multi-dimensional barcode, or any other suitable representation. To ensure uniformity, embodiments of the present invention may utilize pre-existing standards, or any subsequently developed standards. With respect to online shopping, the ability to enter a single string of digits to test for fit in the absence of the garment to be purchased ensures that the garment will fit properly without access to a fitting room.

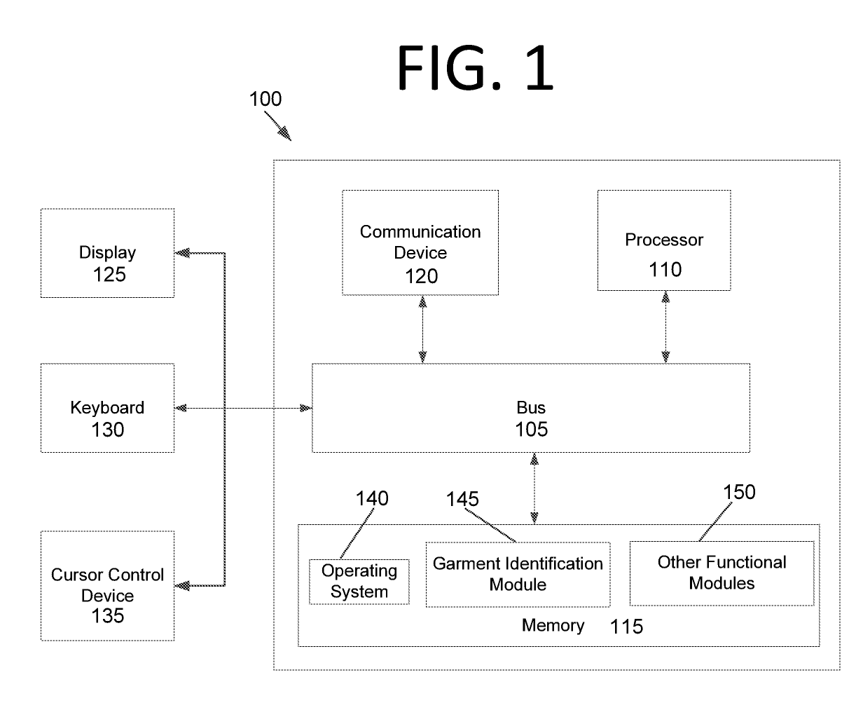

FIG. 1 illustrates a system 100, according to some embodiments of the present invention. System 100 includes a bus 105 or other communication mechanism for communicating information, and a processor 110 coupled to bus 105 for processing information. Processor 110 may be any type of general or specific purpose processor, including a central processing unit (CPU) or application specific integrated circuit (ASIC). System 100 further includes a memory 115 for storing information and instructions to be executed by processor 110. Memory 115 can be comprised of any combination of random access memory (RAM), read only memory (ROM), flash memory, cache, static storage such as a magnetic or optical disk, or any other types of non-transitory computer-readable media or combinations thereof. Additionally, system 100 includes a communication device 120, such as a wireless network interface card, to provide wireless access to a network.

Non-transitory computer-readable media may be any available media that can be accessed by processor 110 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 110 is further coupled via bus 105 to a display 125, such as a Liquid Crystal Display (“LCD”), for displaying information, such as a numerical representation of garment size measurements, to a user. A keyboard 130 and a cursor control device 135, such as a computer mouse, are further coupled to bus 105 to enable a user to interface with system 100.

In one embodiment, memory 115 stores software modules that provide functionality when executed by processor 110. The modules include an operating system 140 for system 100. The modules further include a garment identification module 145 that is configured to provide a garment identification code. System 100 may include one or more additional functional modules 150 that include additional functionality.

One skilled in the art will appreciate that a “system” could be embodied as a digital control console, a personal computer, a server, a console, a personal digital assistant (PDA), a cell phone, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

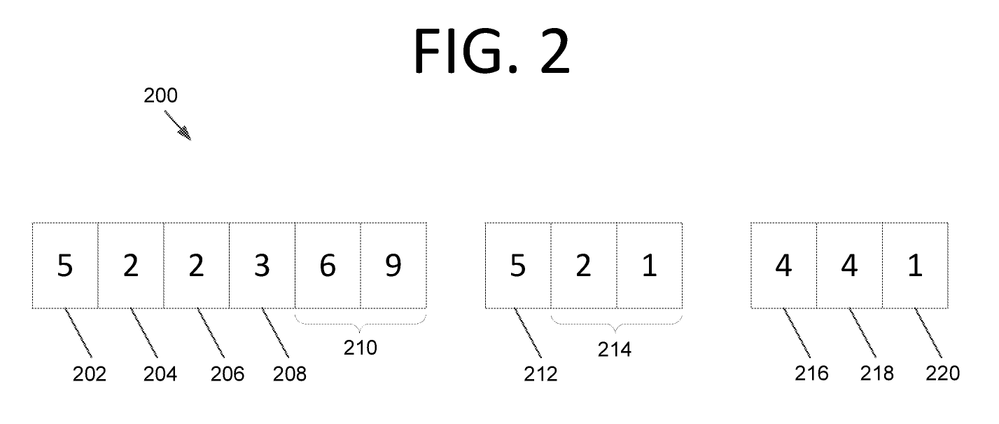

FIG. 2 illustrates a composite reference number 200 for representing garment sizes, according to an embodiment of the present invention. In some embodiments, composite reference number 200 may be implemented by system 100 of FIG. 1. In this embodiment, composite reference number 200 includes a single-digit convention reference number 202, a single-digit base size reference number 204, a single-digit major measurement sort order reference number 206, a single-digit major measurement variation reference number 208, a double-digit height number 210 (in this case, in inches), a single-digit inseam index number 212, a double-digit top length reference number 214, a single-digit back width reference number 216, a single-digit upper arm reference number 218, and a checksum digit 220.

In the example illustrated in FIG. 2, coding system 200 includes the composite reference number 522369 521 441 for a woman's sizing. For many purposes, only the first six digits (and in some cases, only the first four), may be necessary, and in some embodiments, only some of the measurements and/or indices discussed with respect to FIG. 2 are included. Embodiments of the present invention are not limited to the number, type and order of measurements and/or indices that are included. However, for a more specific fit, larger portions of the composite reference number may be used. For all variables provided herein, different standards, numbers of digits, reference numbers, and measuring systems may be used.

While other standard measurement systems may be used in other embodiments, by way of example here, the Voluntary Product Standard is used. Using this standard in this embodiment, an individual would have 10-12 measurements that were taken of his or her body and inputted into a computing device, such as system 100 of FIG. 1. The measurements would then be matched with the appropriate size table and correlative size designation as defined in the Voluntary Product Standard. The representation from this point forward under this standard is in terms of size, not specific measurement. One reason for this is the fluctuation of the size of the human body over time, such as after a large meal. A 38″ waist in the morning could be 36″ by evening, and vice versa. When the Voluntary Product Standard, and the preceding Commercial Standard which it replaced, were created, consideration was given to such factors when creating the size tables.

In this example, convention reference number 202 is “5”. This means that of the nine conventional tables for women's sizing, the table of best fit for the woman of our example is the 5^{th} on the list. Traditionally, these tables have fallen under the description of “Misses”, “Misses Petite”, “Women's”, “Women's Petite”, “Juniors”, etc. By assigning a reference number to the different sizing conventions, the appropriate sizing convention can be identified.

Base size reference number 204 is “2”. This means that on the Women's Misses table, the smallest size number of the three major measurements (bust, waist and hips) was second on the table. Conventionally, this would be a size 12 in Misses.

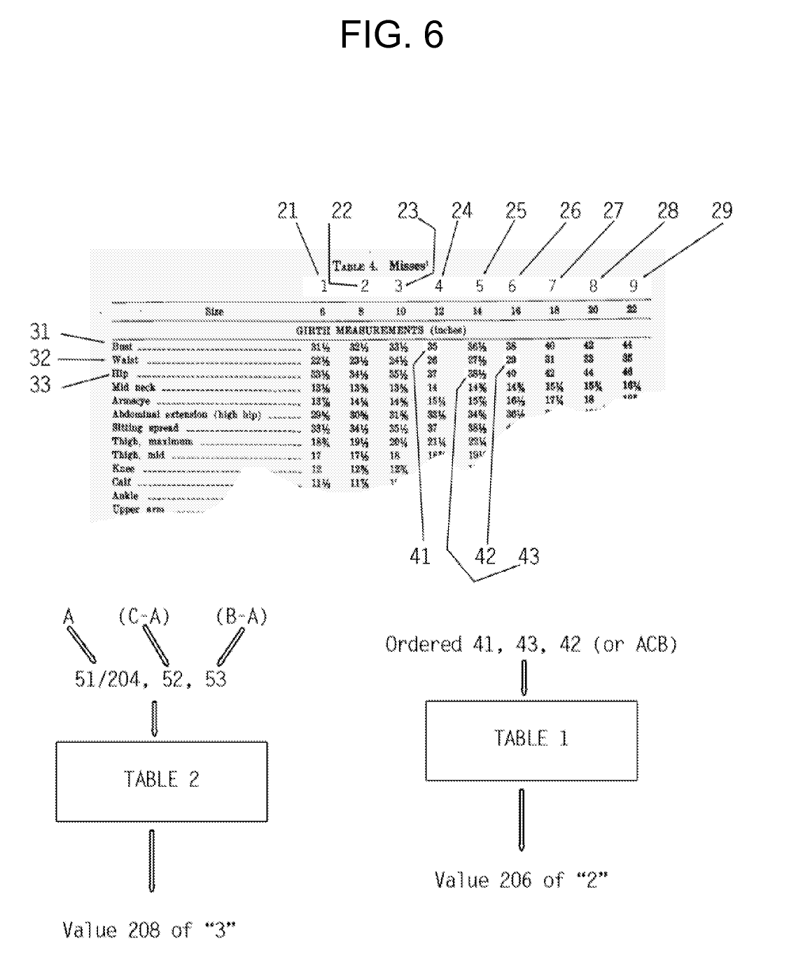

Major measurement sort order reference number 206 is “2”. This represents the order from smallest to largest of her three major measurements: bust, waist and hips. Given the predetermined assignation of the major measurements (shown below in Table 1), a number from 1 to 6 is given. In Table 1, bust is represented by “A”, waist is represented by “B” and hips are represented by “C”. The values in parentheses represent the corresponding entries in the Women's Misses table illustrated in FIG. 6.

TABLE 1

| Major Measurement Sort Order | Reference Number |
|---|---|
| ABC (41, 42, 43) | 1 |
| ACB (41, 43, 42) | 2 |
| BAC (42, 41, 43) | 3 |
| BCA (42, 43, 41) | 4 |
| CAB (43, 41, 42) | 5 |
| CBA (43, 42, 41) | 6 |
| Straight Size w/o Variation | 7 |

The straight size without variation indicates the lucky case with a “true” size fit. Straight sizing represents a body that has no major measurement deviation from the standard, whereby all major measurements fall under the same size designation. A value of “7” for major measurement sort order reference number 206, for example, indicates an equivalent bust size designation, waist size designation and hip size designation (e.g., a size 12 bust, size 12 waist and size 12 hips). This designation is deemed “lucky” because it relieves the necessity for a major measurement variation reference number 208 and allows for more specific information to be stored in the slot otherwise occupied by this number.

Major measurement variation reference number 208 is “3”. This denotes the degree of variation from base size reference number 204 in the order defined by major measurement sort order reference number 206. This is further illustrated in Table 2 below, where reference labels 51, 52 and 53 refer to the Women's Misses table of FIG. 6.

TABLE 2

| Major Measurement Variation | | | Reference |
|---|---|---|---|
| 51/204 | 52 | 53 | Number |
| No Variation | No Variation | Base Size +1 | 1 |
| No Variation | Base Size +1 | Base Size +1 | 2 |
| No Variation | Base Size +1 | Base Size +2 | 3 |
| No Variation | Base Size +1 | Base Size +3 | 4 |
| No Variation | No Variation | Base Size +2 | 5 |
| No Variation | Base Size +2 | Base Size +2 | 6 |
| No Variation | Base Size +2 | Base Size +3 | 7 |
| No Variation | No Variation | Base Size +3 | 8 |
| No Variation | Base Size +3 | Base Size +3 | 9 |

For the woman in our example, the value of “3” for major measurement variation reference number 208 means that the variation in her three major measurements is 0 for the first (or lowest) measurement, +1 for the middle measurement and +2 for the largest measurement. In combination with the value of “2” for measurement sort order reference number 206 and the value of “2” for base size reference number 204, the value of “3” for major measurement variation reference number 208 gives us the following in terms of clothing size number: Ordered A-C-B, 2-3-4 (per the major measurement variation number, +1 is added to the middle measurement and +2 is added to the largest measurement) translates on the Misses size table to a size 12 (or second on the table) bust, a size 14 (or third on the table) hips, and a size 16 (or fourth on the table) waist. When reordered A-B-C, her measurements would be (in clothing size terms) 12-16-14 (bust-waist-hips). From the table, this translates to 34″-30″-38″.

Height number 210 is “69”, which is how many inches tall she is. Aside from giving her height, height number 210 also provides a reference with respect to other length measurements. Because the size tables are based on women 5′ 4″ to 5′ 6″ in height (or 64″ to 66″), adjustments need to be made to subsequent numbers (especially the top length number) should height vary from the table standard. While inches are used in this example, any suitable measurement size may be used, such as centimeters, decimeters, millimeters, etc. The number of digits used may need to be adjusted accordingly (for instance, three digits for centimeters).

Inseam index number 212 is “5”. Table 3 below provides values for a variable x, that is arrived at by dividing the inseam measurement by the height.

TABLE 3

| Inseam Index Number | xᵢ Value |
|---|---|
| 0 | −5% |
| 1 | −4% |
| 2 | −3% |
| 3 | −2% |
| 4 | −1% |
| 5 | 0% |
| 6 | 1% |
| 7 | 2% |
| 8 | 3% |
| 9 | 4% |

From Table 3, an inseam index number of 5 indicates that the value of xᵢ is 0%. Accordingly, her inseam is the usual proportional percentage, which is 45% of her height. This yields an inseam of 69″*0.45, or approximately 31″.

Top length reference number 214 is “21”. This two-digit number is arrived at by the same kind of manipulation as major measurement sort order reference number 206 and major measurement variation reference number 208. Three length measurements (front waist, back waist and shoulder-to-bust/mid-chest) are sorted by the first number and variations are given by the second. Also, this number is adjusted in the formula according to height. Since standard sizing assumes a given height range, for those who are outside of this range, the length number will be shifted automatically one way or the other, depending on where the measured person falls.

Backwidth reference number 216 is “4”.

TABLE 4

| Backwidth Reference Number | Size Variation |
|---|---|
| 1 | −4 sizes |
| 2 | −3 sizes |
| 3 | −2 sizes |
| 4 | −1 size |
| 5 | same size |
| 6 | +1 size |
| 7 | +2 sizes |
| 8 | +3 sizes |
| 9 | +4 sizes |
| 0 | special needs |

Given Table 4 above, the variation in size from the value of “2” for base size reference number 204 is −1 size. This measurement may be important since the breast or cup measurement can be estimated by the ratio of backwidth to chest circumference (or bust measurement). This information is useful in that it indicates how a garment might actually fit, or more specifically “hang” or “drape” over the torso. For example, a woman with a proportionally large breast size in relation to her bust circumference would have the majority of that bust circumference carried in the front part of her body. Conversely, a proportionally small backwidth size would lead to the same conclusion. For clothing items such as blouses or dress shirts with side-seam construction, it may not be aesthetically desirable for that side seam to follow the front-to-back contour as if being pulled forward by proportionally large breasts. Rather, it might be optimal for that side seam to appear to run in a straight line along the vertical side of the torso. Since the backwidth measurement is in essence a partial measurement of the circumference of the bust, a ratio of back measurement to bust measurement can yield an estimate for breast (or front chest) size.

Upper arm reference number 218 is “4”. This is arrived at in the same way as backwidth reference number 216, so Table 4 also applies to upper arm reference number 218.

Checksum digit 220 is “1”. The checksum digit may be a Luhn Algorithm checksum digit (see U.S. Pat. No. 2,950,048), but any suitable checksum mechanism may be used. The Luhn Algorithm checksum digit prevents the transposition of numbers when entered in a string.

In addition to the numbers shown in composite reference number 200, other index and/or measurement numbers may also be included in some embodiments. For example, an accessory index number may be included. The accessory index number may be a two-digit number whereby the 10¹ digit indicates a place on a table's x-axis, and the 10⁰ digit denotes a place on the table's y-axis. For instance, along the x-axis may be hat sizes and along the y-axis may be shoe sizes, or vice versa. Larger numbers of digits and different bases for numbering systems may also be used. Rather than compressing these values, in some embodiments, hat and/or shoe sizes may simply be included as-is.

Another index that may be included in some embodiments is a four-digit “tailor's code”. In cases where a person's size or variation might exceed those on the standard tables, such a code could be used to further “tweak” the composite number, giving more specific data for key measurements. A “tailor's code” comprises any one of multiple combinations of reference numbers to further specify a special need. In an extreme example for description purposes, the first reference number of the “tailor's code” could indicate a type of physical deformity such as an amputated limb or post-mastectomy bust. The following three numbers would make reference through a predetermined table to possible remedies or requirements for clothing intended for individuals with special needs as indicated by the first number of the tailor's code. A less extreme example would include an individual whose major measurements vary more than three ordinal degrees. Since major measurement variation reference number 208 only accounts for three degrees of variation, the tailor's code could reference this condition and make reference to possible remedies or requirements.

There is a large quantity of implicit information that is requisite to the embodiment above, and variation based on the implicit information is possible. For example, for men, there is likely no need for a convention reference number for the Voluntary Product Standard since there is only one table for men. The extra space allotted from the removal of this number allows for a neck size to be included in the composite. There are similar modifications that can be made for children, toddlers and teens. The information is implicit because this system may assume that each person knows his or her own sex and age classification. Men may have a men's composite number, women a women's composite number, and for children, toddlers and teens, the same holds true.

For men's clothing, the general process for obtaining the composite number is similar; however, the requisite numbers are different. One major difference between men's and women's composite numbers is the absence of a convention reference number 202. For men, there is only one “convention” under the Voluntary Product Standard. An example of a men's composite fitting number is 657 714 166. The base size reference number 204 with a value of 6 (the sixth ordinal size in Men's Commercial Standard Sizing, or a size 46) starts the men's composite reference number in the absence of need for a convention reference number. This is followed by the Major Measurement Order Reference Number 206 with a value of 5 (CAB from Table 1), and then a major measurement variation reference number 208 of 7 (from Table 2). The next three numbers reference body length measurements with a two-digit height reference number 210 of 71 and inseam reference number 212 of 4 (from Table 3). The next three numbers are specific to upper body measurements necessary for proper shirt fit. Arm length reference number 222 is 1; neck size reference number 224 is 6; and upper arm reference number 226 is 6 (all three derived from Table 4). A children's reference number would also differ, and in some cases may only require four digits—a convention reference number, a base size reference number, a major measurement sort order reference number and a measurement variation reference number. In children, the variations in the other measurements may be too small to be worth accounting for.

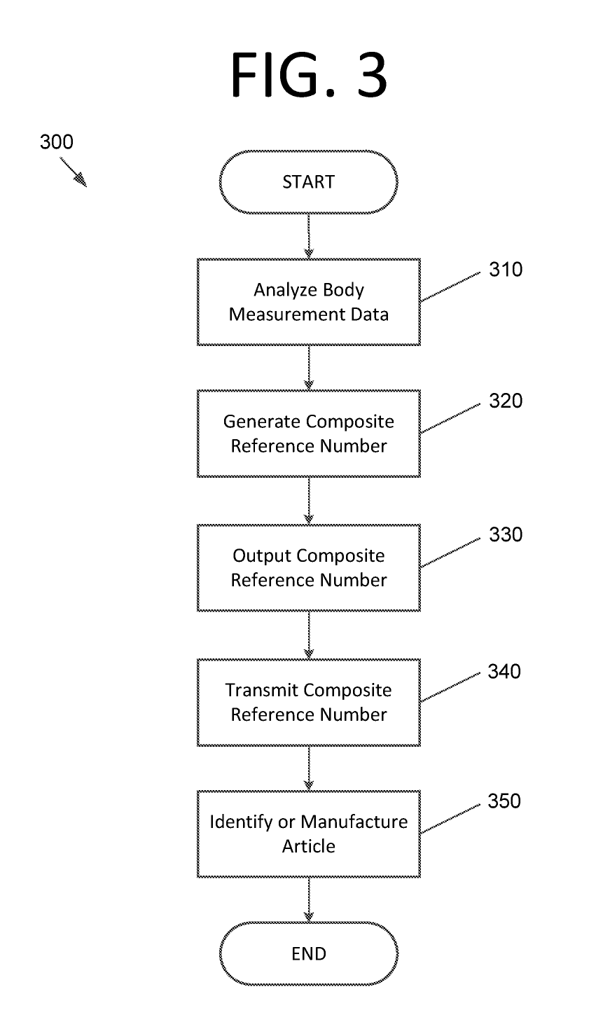

FIG. 3 illustrates a flowchart 300 for a garment fitting identification system, according to an embodiment of the present invention. In some embodiments, the operations of flowchart 300 may be carried out by a computer program embodied on a non-transitory computer-readable medium, such as garment identification module 145, which is stored on memory 115 of system 100 in FIG. 1.

The process begins at 310 with analyzing data indicative of a consumer's body measurements. Next, the system carrying out the process generates a composite reference number at 320. The composite reference number represents measurements and indicia of the consumer's garment size based on a standard measurement system. The standard measurement system may be the Voluntary Product Standard in some embodiments. The composite reference number may include a convention reference number, a base size reference number, a major measurement sort order reference number and a measurement variation reference number. The composite reference number may also include a height number and an inseam index number. The composite reference number may further include a top length reference number, a backwidth reference number, an upper arm reference number and a checksum digit.

The composite reference number may additionally include an accessory index number. In some embodiments, the accessory index number denotes a two-dimensional place on a table for sizes of two accessories, where a position on an x-axis denotes a size of a first accessory and a position on a y-axis denotes a size of a second accessory. The accessory index number may also be an uncompressed numerical string representing the sizes of the associated accessories, such as shoe size and hat size. In some embodiments, the composite reference number also includes a tailor's code that may be used to further tweak the composite number where a consumer's size or variation exceed those of tables of the standard measurement system. The composite reference number may be specific to women, men, children, toddlers, or teens, depending on the consumer to whom the composite reference number pertains.

The system then outputs the composite reference number at 330 to a device such as visual display device, a printer, and/or a card reader/writer. The composite reference number is transmitted at 340 to an internal or external computer system or network of a retailer or manufacturer, depending on who is using the system. For instance, a retailer or manufacturer may use the system themselves, or the system may be used by a tailor, an individual user (via, for example, their PC, laptop, smart phone, tablet computer, etc.), or any other individual or business. The systems that may use the system described herein are not limited by this disclosure. The computer system or network of the manufacturer or retailer then identifies a pre-made article, or manufactures a new article, that fits the consumer based on the composite reference number at 350.

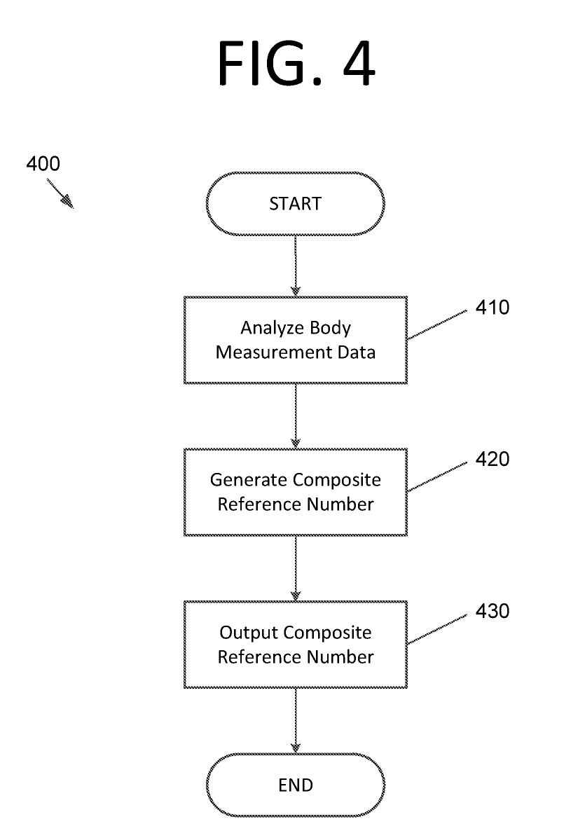

FIG. 4 illustrates a flowchart 400 for a garment fitting identification system, according to an embodiment of the present invention. The process illustrated in flowchart 400 may be carried out by a computer system, such as system 100 of FIG. 1. The process begins with analyzing data retrieved from memory of the system carrying out the process that is indicative of a consumer's body measurements at 410. The system then generates a composite reference number at 420 that represents measurements and indicia of the consumer's garment size based on a standard measurement system.

The composite reference number may include a convention reference number, a base size reference number, a major measurement sort order reference number and a measurement variation reference number. The composite reference number may also include a height number and an inseam index number. The composite reference number may further include a top length reference number, a backwidth reference number, an upper arm reference number and a checksum digit. The system then outputs the composite reference number at 430 to a visual display device, a printer, or a card reader/writer.

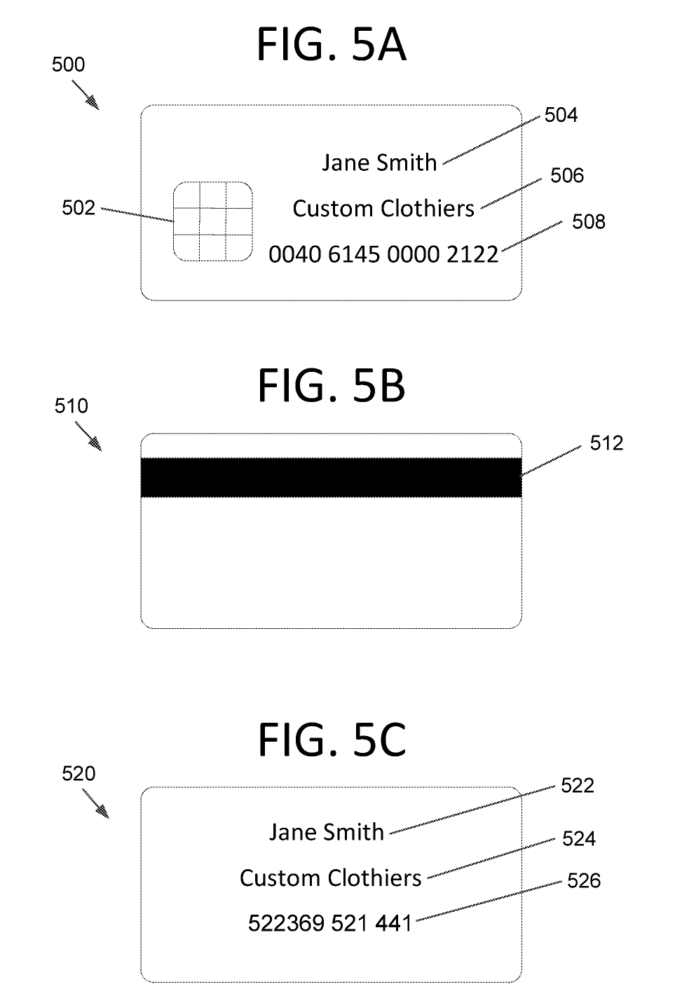

FIG. 5A illustrates a smart card 500 storing a composite reference number, according to an embodiment of the present invention. The smart card has a small chip 502 that stores the composite reference number. Smart card 500 has a consumer name 504, a store name 506 and a credit card number 508 printed on its surface. However, in some embodiments, smart card 500 does not function as a credit card, and the information printed, etched, engraved, or otherwise placed on the card may differ according to the store or manufacturer's needs.

FIG. 5B illustrates a card 510 with a magnetic strip 512 storing a composite reference number, according to an embodiment of the present invention. Any other indicia or numbers that are desired may also be stored on magnetic strip 512, and any text or designs that are desired may be printed on the front and/or back of card 510.

FIG. 5C illustrates a card 520 on which a composite reference number 526 is printed, according to an embodiment of the present invention. Card 520 also has a consumer name 522 and a store name 524 printed on its surface.

FIG. 6 illustrates the Women's Misses table of the Voluntary Product Standard, according to an embodiment of the present invention. Single-Digit Ordinal Size Numbers 21-29 represent and replace for truncation purposes the standard double-digit size demarcations standard in the existing Women's Misses table. Individual bust measurement 41, Individual waist measurement 42 and Individual hip measurement 43 yield a correlative single-digit ordinal size number for each of the three major measurement categories (bust 31, waist 32 and hip 33) from a predetermined table of size to measurement correlations. In the example provided, the measured woman has a bust size 41 taken from major measurement category 31 yielding a single-digit ordinal size number 24 with a value of “4”. She has a waist size 42 taken from major measurement category 32, yielding a single-digit ordinal size number 26 with a value of “6”. She has a hip size 43 taken from major measurement category 33 yielding a single-digit ordinal size number 24 with a value of “5”. Assigning the letter “A” to bust size 41, “B” to waist size 42 and “C” to hip size 43, and then placing them in order from smallest correlated single-digit ordinal number to largest correlated single-digit ordinal number, a major measurement sort order value of “ACB” is yielded as listed in Table 1 (above). From Table 1, a major measurement sort order reference number 206 of “2” is arrived at from the example measurement.

Table 2 further illustrates how, from the given example and measurement sort order reference number 206 as illustrated in FIG. 6 and derived from Table 1, the major measurement variation number 208 is derived from Table 2. Taking the major measurement sort order from Table 1 in the example provided, the major measurement with the lowest ordinal size value is the bust size 41 with a value of “4”. This is represented in FIG. 6 by reference number 51. Coincidentally this is also the same as the single-digit base size reference number 204. The next highest single-digit ordinal number belongs to the woman's hip size 43. Middle sort order variation number 52 is arrived at by subtracting the value of the single-digit base size reference number 204 from the single-digit ordinal number belonging to the second ordered major measurement size. The largest sort order variation number 53 is arrived at, in kind, by subtracting the value of the single-digit base size number 204 from the single-digit ordinal number belonging to the largest of the three major measurements. Using these variations, a single-digit major measurement variation number can be derived from Table 2.

Some embodiments of the present invention provide a composite reference number that encodes measurements and indicia of a consumer for use in fitting clothing. The measurements and indicia encoded by the composite reference number may be derived from a standard measurement system, such as the Voluntary Product Standard. Through the use of this composite reference number, consumers may obtain custom-fitted clothing without trying the articles on. This is especially beneficial for transactions over the Internet, where consumers cannot physically try clothing on before purchase.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a non-transitory computer-readable medium, the program configured to cause a processor to:
analyze data indicative of a consumer's body measurements; and
generate a composite reference number that represents measurements and indicia of the consumer's garment size based on a standard measurement system.

2. The computer program of claim 1, wherein the composite reference number comprises a convention reference number, a base size reference number, a major measurement sort order reference number and a measurement variation reference number.

3. The computer program of claim 2, wherein the composite reference number further comprises a height number and an inseam index number.

4. The computer program of claim 3, wherein the composite reference number further comprises a top length reference number, a backwidth reference number, an upper arm reference number and a checksum digit.

5. The computer program of claim 1, wherein the standard measurement system is the Voluntary Product Standard.

6. The computer program of claim 1, wherein the composite reference number comprises an accessory index number.

7. The computer program of claim 6, wherein the accessory index number denotes a two-dimensional place on a table for sizes of two accessories, where a position on an x-axis denotes a size of a first accessory and a position on a y-axis denotes a size of a second accessory.

8. The computer program of claim 1, wherein the composite reference number comprises a tailor's code that may be used to further tweak the composite number where a consumer's size or variation exceed those of tables of the standard measurement system.

9. The computer program of claim 1, wherein the composite reference number is specific to women, men, children, toddlers, or teens, depending on the consumer to whom the composite reference number pertains.

10. The computer program of claim 1, wherein the program further causes the processor to:
output the composite reference number to a visual display device, a printer, or a card reader/writer.

11. The computer program of claim 1, wherein the program further causes the processor to:
transmit the composite reference number to a computer system or network of a retailer or manufacturer; and
identify a pre-made article, or manufacturing a new article, that fits the consumer based on the composite reference number.

12. An apparatus, comprising:
a computer-readable magnetic strip or chip, wherein the magnetic strip or chip stores a composite reference number that represents measurements and indicia of the consumer's garment size based on a standard measurement system.

13. The apparatus of claim 12, wherein the composite reference number comprises a convention reference number, a base size reference number, a major measurement sort order reference number and a measurement variation reference number.

14. The apparatus of claim 13, wherein the composite reference number further comprises a height number and an inseam index number.

15. The apparatus of claim 14, wherein the composite reference number further comprises a top length reference number, a backwidth reference number, an upper arm reference number and a checksum digit.

16. A computer-implemented method, comprising:
analyzing, via a processor, data that is indicative of a consumer's body measurements;
generating, via the processor, a composite reference number that represents measurements and indicia of the consumer's garment size based on a standard measurement system;
transmitting the composite reference number to a computer system or network of a retailer or manufacturer; and
identifying a pre-made article, or manufacturing a new article, that fits the consumer based on the composite reference number.

17. The computer-implemented method of claim 16, wherein the composite reference number comprises a convention reference number, a base size reference number, a major measurement sort order reference number and a measurement variation reference number.

18. The computer-implemented method of claim 17, wherein the composite reference number further comprises a height number and an inseam index number.

19. The computer-implemented method of claim 18, wherein the composite reference number further comprises a top length reference number, a backwidth reference number, an upper arm reference number and a checksum digit.

20. The computer-implemented method of claim 16, further comprising:
outputting the composite reference number to a visual display device, a printer, or a card reader/writer.
